(19) United States
(12) Patent Application Publication
(10) Pub. No.: US 2010/0115385 A1
(43) Pub. Date: May 6, 2010

(54) DETECTING DATA-ACCESS-ELEMENT-SELECTION ERRORS DURING DATA ACCESS IN DATA-STORAGE ARRAYS

(75) Inventors: NAVEEN BATRA, Haryana (IN); JITENDRA DASANI, Uttar Pradesh (IN)

Correspondence Address: GRAYBEAL JACKSON LLP, 400 - 108TH AVENUE NE, SUITE 700, BELLEVUE, WA, 98004, US

(73) Assignee: STMICROELECTRONICS PVT. LTD., GREATER NOIDA (IN)

(21) Appl. No.: 12/613,399

(22) Filed: Nov. 5, 2009

(30) Foreign Application Priority Data
Nov. 5, 2008 (IN) 25.2/DEL/2008

(51) Int. Cl. G06F 11/07

(52) U.S. Cl. 714/799; 714/E11.024

(57) ABSTRACT

An embodiment of the present disclosure relates to detection of data access element selection errors during data access in data storage arrays. An embodiment of the disclosure describes a system including a data storage array comprising a first and a second error identifier. The error identifiers generate an error signal in case multiple data access elements are selected or no data access element is selected, respectively. A system for detection of data-access-element-selection errors further comprises a common error-signal generator which provides an output when an error signal is generated by either of said error identifiers.

### PRIORITY CLAIM

The instant application claims priority to Indian Patent Application No. 2502/Del/2008, filed Nov. 5, 2008, which application is incorporated herein by reference.

### TECHNICAL FIELD

An embodiment of the present disclosure relates to data-storage-array devices and more specifically to detection of data-storage element-selection-errors during data access in data-storage arrays.

### BACKGROUND

The term “word-line” has been used interchangeably with “data-access elements”, “data-storage element” has been used interchangeably with Memory Cell, and “Memory” has been used interchangeably with “data-storage array”.

Soft errors and hard errors are a common occurrence in address decoding, which at times occur due to erroneous selection of a data-access element or word-line in the memory. These errors reduce the probability of achieving a low value of Failure in Time (FIT), thus presenting a huge challenge in this arena.

Word-line selection is enabled by use of word-line generation circuitry, and any failure in the circuitry could lead to a wrong output or to data corruption in the memory. The following fault types and failure modes commonly occur in word-line generation circuitry for both hard errors/failures and soft errors/failures:
Error due to no word-line selection occurs when no word-line has been selected in the data-storage array
Error due to multiple word-line selection occurs when more than one word-line has been selected in a data-storage array instead of a single word-line.
Error due to wrong word-line selection occurs when a word-line is mapped to an address other than the given address line.

A single failure (e.g., short/open) may lead to a no-word-line failure or to a multiple-word-line failure, while for a wrong-word-line failure at least two failures (short/open) are typically required. Chances of at least two failures happening at the same time in one data-access cycle are very rare. Therefore, because no-word-line and multiple-word-line failures often result in the failure of read/write operations, the detection of such errors may be crucial.

### BRIEF DESCRIPTION OF DRAWINGS

Features and aspects of various embodiments of the disclosure will be better understood when the following detailed description is read with reference to the accompanying drawings in which like characters represent like parts throughout the drawings:

FIG. 1 describes a system for detection of selection errors during each data access in data-storage arrays, according to an embodiment of the disclosure.

FIG. 2 illustrates an error identifier according to an embodiment of the disclosure.

FIG. 3 describes a distributed arrangement of charge/discharge elements to generate reference-voltage levels according to an embodiment of the disclosure.

FIG. 4 describes a system for detection of selection errors in data access in a multi-bank type data-storage array according to an embodiment of the disclosure.

FIG. 5 describes a method for detection of selection errors during each data access in data-storage arrays according to an embodiment of the disclosure.

FIG. 6 illustrates a method for error identification according to another embodiment of the disclosure.

### DETAILED DESCRIPTION

Embodiments of the present disclosure will be described in detail with reference to the accompanying drawings. However, the present disclosure is not limited to these embodiments. The present disclosure may be modified in various forms. Furthermore, in the accompanying drawings, like reference numerals are used to indicate like components.

Various embodiments of the present disclosure teach detection of data-access-element-selection errors during data access in a data-storage array. According to an embodiment of the disclosure a system including a data-storage array comprises a first error identifier and a second error identifier to generate an error signal in case of data-access-element-selection errors. The first error identifier generates an error signal on selection of multiple data-access elements in the data-storage array. The second error identifier generates an error signal on absence of data-access element selection in the data-storage array.

An embodiment of the present disclosure comprises a common error-signal generator which provides an output when an error signal is generated by either of said error identifiers.

In accordance with an embodiment of the disclosure, each of said error identifiers comprise a first reference-voltage-level generator, a second reference-voltage-level generator, a voltage-level detector and a comparator. The first error identifier generates a first reference-voltage level greater than a voltage level produced when a single data-access element is selected and less than a voltage level produced when no data-access element is selected. The second reference-voltage-level generator generates a second reference-voltage level less than the voltage level produced when a single data-access element is selected and greater than the voltage level produced when multiple data-access elements are selected. The voltage-level detector detects the voltage produced when a data-access element is selected in the data-storage array. The comparator then compares the detected-voltage level with the first and second reference-voltage level to identify error if any.

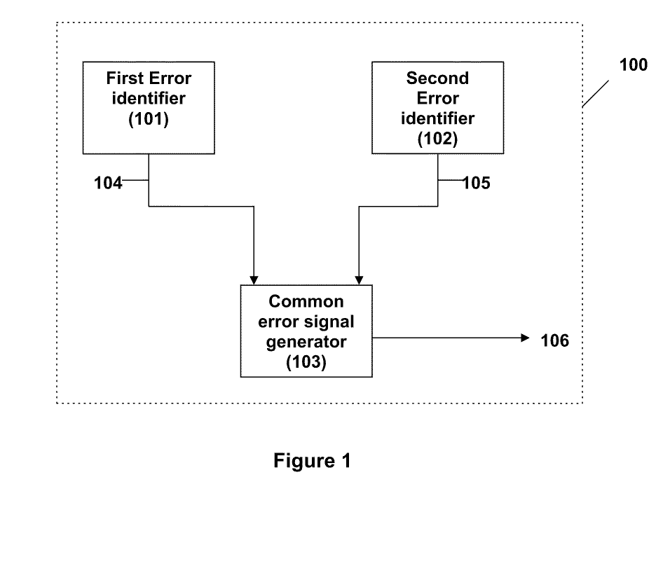

FIG. 1 illustrates a system 100 for detection of data-access-element-selection errors during data access in data-storage arrays according to an embodiment of the disclosure. A first error identifier 101 generates an error signal on absence of selection of a data-access element while a second error identifier 102 generates an error signal on multiple selection of data-access elements. Error identifiers 101 and 102 output signals 104 and 105, respectively, to indicate data-access-element-selection errors.

According to another embodiment of the disclosure, error signals 104 and 105 enable a common error-signal generator 103 to provide an output 106 on generation of said error signals. According to an embodiment of the disclosure, separate error signals are output, while according to another embodiment of the disclosure, an output is provided by a common error-signal generator. Accordingly, the present embodiment is useful in a multi-bank data storage array where a separate error signal (if any selection error occurs) is generated for each bank.

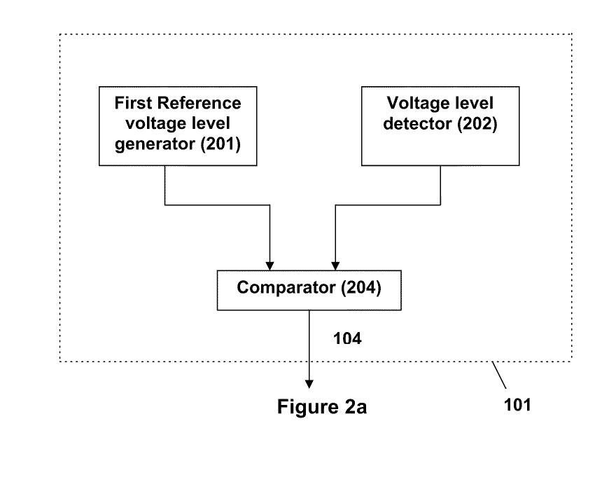

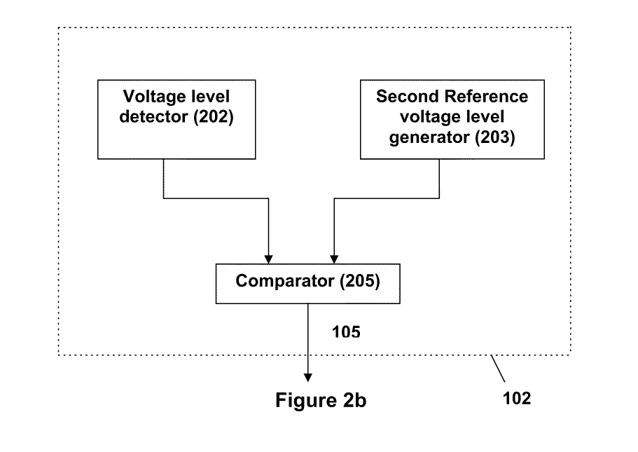

FIGS. 2a, 2b refer to error identifiers 101, 102 according to an embodiment of the disclosure. The error identifiers are used to identify occurrence of data-access-element-selection errors as specified under description of FIG. 1. Error identifiers 101, 102 comprise comparators 204, 205; reference-voltage-level generators 201, 203, respectively, and a voltage-level detector 202. The comparators compare reference-voltage levels generated by the reference-voltage-level generators 201, 203, respectively, with a voltage level detected by the voltage-level detector 202. The detected voltage level is produced by the selected data-access element. The first reference-voltage-level generator 201 generates a first reference-voltage level greater than the voltage level produced when a single data-access element is selected and less than the voltage produced by when no data-access element is selected. The second reference-voltage-level generator 203 generates a second reference-voltage level less than the voltage level produced when a single-data-access element is selected and greater than the voltage produced when multiple data-access elements are selected. Each of said reference-voltage-level generators use at least one reference-data-access element to produce a desired reference-voltage level.

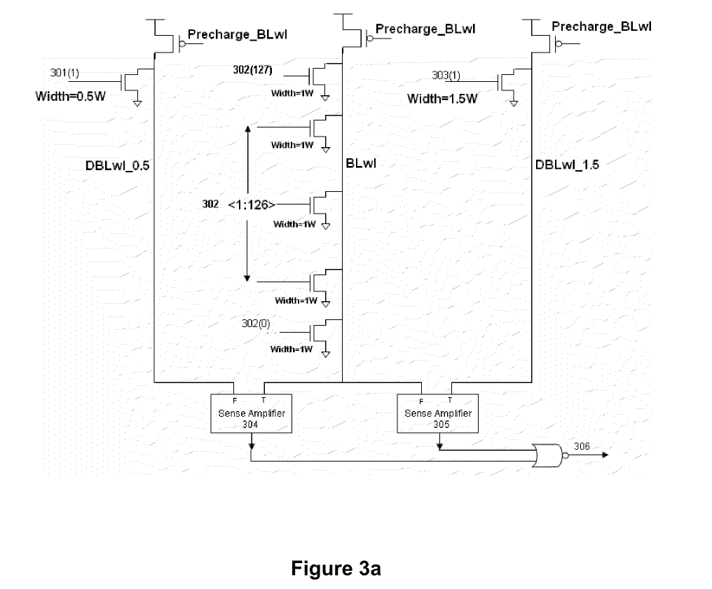

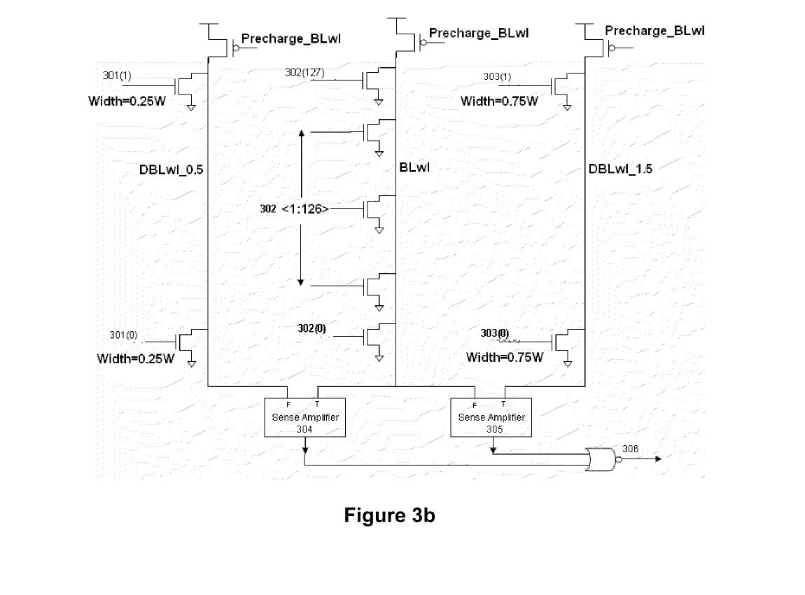

FIG. 3a illustrates a reference-data-access element with a distributed structure of charge/discharge elements to generate desired reference-voltage levels in accordance with an embodiment of the disclosure. The reference-voltage-level generators generate the reference-voltage levels on the basis of the distributed structure of the charge/discharge elements. Pre-defined widths of these elements are used for generation of the reference-voltage level. The actual data-access element to be selected has charge/discharge elements 302(0), 302<1:126> and 302 (127) of approximate widths W and produces a voltage level when selected by the user. Reference-data-access element with charge/discharge elements 301(0) and 301(1) with widths approximately equal to 0.5 W produces a reference-voltage level which indicates the error of no selection of a data-access element. Reference-data-access element with charge/discharge elements 303(0) and 303(1) with widths approximately equal to 1.5 W indicates the error due to multiple data-access element selection. Sense amplifiers 304 and 305 act as comparators to compare voltage levels produced on selection of a data-access element and the reference-voltage levels. The output of the data-access elements 301, 302 and 303 are applied as F and T to the sense amplifiers 304 and 305. The outputs of the sense amplifiers are then processed through a logic gate 306 to produce a combined error signal.

That is, the transistor 301(1) is designed, when activated with an access voltage on its gate, to draw less current than one of the transistors 302 when activated with an access voltage on its gate—drawing less current results in a higher voltage on the bit line DBLwl_{—}0.5 than on the bit line BLwl due to the slower discharge time for DBLwl_{—}0.5. So if the sense amplifier 304 senses that the transistor 301(1) is drawing more current than the group of transistors 302 is drawing on the line BLwl, then this indicates that none of the transistors 302 is activated for access.

Furthermore, the transistors 303(1) is designed, when activated with an access voltage on its gate, to draw more current than one of the transistors 302 when activated with an access voltage on its gate—drawing more current results in a lower voltage on the bit line DBLwl_{—}1.5 than on the bit line BLwl due to the faster discharge time for DBLwl_{—}1.5. So if the sense amplifier 305 senses that the transistor 303(1) is drawing less current than the group of transistors 302 is drawing on the line BLwl, then this indicates that more than one of the transistors 302 is activated for access.

As an example of the above described embodiment, if no word-line or data-access element is selected, the T generated by reference-data-access element 302 is equal to ‘1’ and the output generated at sense amplifier 304 is ‘1’. The output generated at sense amplifier 305 is ‘0’ and thus after being applied to the logic gate 306 the error signal generated is low i.e. ‘0’ which indicates error. Therefore, error occurring due to no selection of a data-access element is detected.

The occurrence of an error is indicated according to the following table:

| | Output | Output | Error | Operation |
|---|---|---|---|---|
| | at 304 | at 305 | Signal | Summary |
| Initial Stage | 0 | 0 | 1 | No operation |
| Correct selection of | 0 | 0 | 1 | Correct memory |
| data-access element | | | | operation |
| Error in selection of | 1 | 0 | 0 | No data-access |
| data-access element | | | | element selection |
| Error in selection of | 0 | 1 | 0 | Multiple data- |
| data-access element | | | | access selection |

The number of charge/discharge elements 301 and 303 and their respective widths are modified according to the user requirement, e.g., according to the reference-voltage levels required by the application.

In another embodiment of the present disclosure, reference-column structures have discharge elements distributed equally on the top and bottom of the structures as shown in FIG. 3b to reduce the effect of the reference column on the voltage level of the column at the comparator.

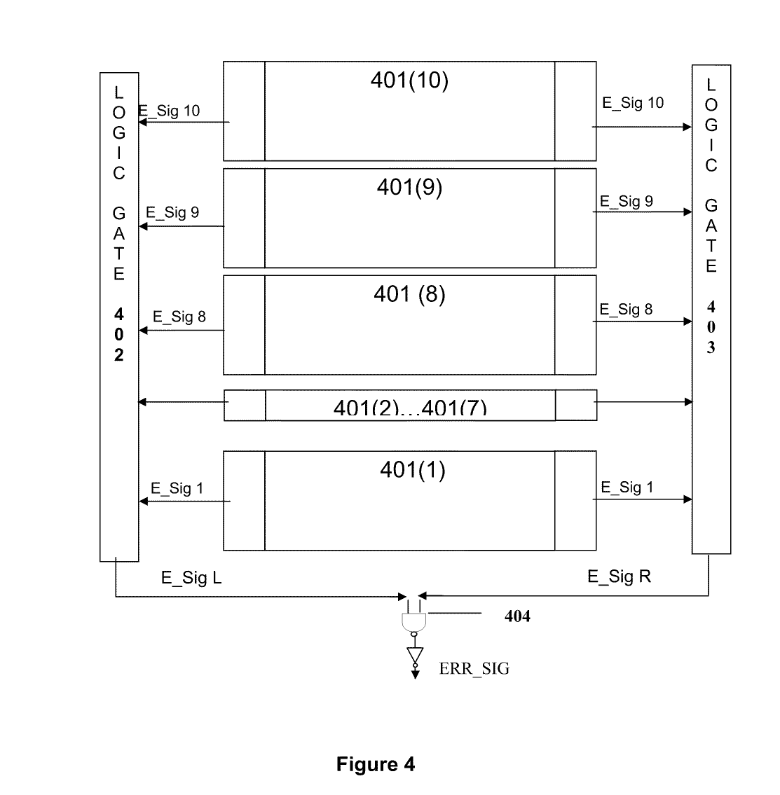

FIG. 4 shows generation of error signals for a split type data-storage array in a multi-bank data-storage array 401(1), 401<2:7>, 402(8), 402(9) and 401(10) according to an embodiment of the disclosure. The error signals E_Sig 1, E_Sig 2, . . . E_Sig 10 are generated for the left terminal and right terminal of the data-storage array. An error in selection of a data-access element for either terminal of a bank generates an error signal. Error signals output by both terminals E_Sig 1, E_Sig 2, . . . E_Sig 10 of the various banks are then applied to a logic gate 402 and 403 respectively. The error signals E_Sig L and E_Sig R are applied to another logic gate 404 to produce a common error signal ERR_SIG to indicate the occurrence of a data-access-element-selection error.

According to an embodiment of the disclosure, the error signals generated at the left terminal and right terminal of the bank data-storage arrays are output separately to indicate the individual occurrence of an error condition.

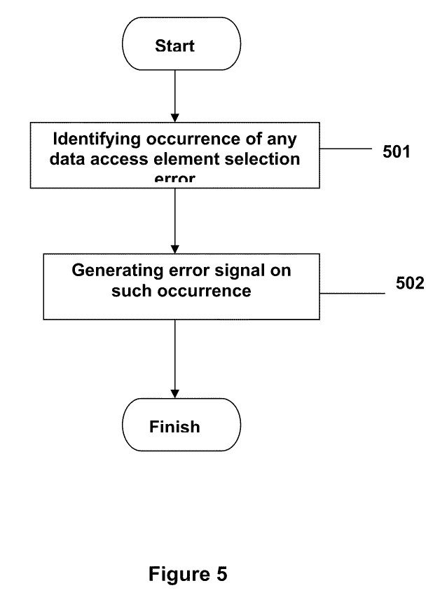

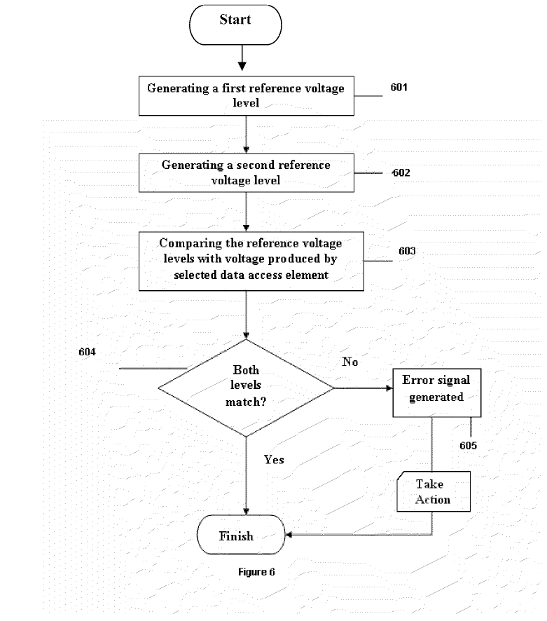

Embodiments of the method for detecting selection errors during data access in data-storage arrays during each data access and a method for error identification are described in FIG. 5 and FIG. 6. The methods are illustrated as a collection of blocks in a logical flow graph, which represents a sequence of operations that may be implemented in hardware, software, or a combination thereof. The order in which the process is described is not intended to be construed as a limitation, and any number of the described blocks may be combined in any order to implement the process, or an alternate process.

FIG. 5 illustrates a flow chart for a method for detecting data-access-element-selection errors during data access in data-storage arrays. The occurrence of a selection error is identified 501 by means of a first and second error identifier and the occurrence of the selection error is indicated by generation of an error signal 502. According to an embodiment of the disclosure, a common error-signal generator provides an output on generation of either of said error signals. In accordance with another embodiment of the disclosure, the error signals are output separately. The errors that are identified and then signaled are as below:
Absence of selection of a data-access element.
Multiple selections of data-access elements.

FIG. 6 describes a method for error identification implemented by each error identifier. A first reference-voltage level is generated 601 by a first reference-voltage level generator. Simulataneously, a second reference-voltage level is generated 602 by a second reference-voltage-level generator The first reference-voltage level generated is greater than the voltage level produced when a single data-access element is selected and less than the voltage level produced when no data-access element is selected. The second reference-voltage level generated is less than the voltage level produced when a single data-access element is selected and greater than the voltage produced when multiple data-access elements are selected.

The two reference-voltage levels are then compared to the voltage level produced by selection of a data-access element 603. If both levels match 604, memory operations taking place are correct. However, if the levels do not match, then an error signal is generated 605. The generated error signal indicates the occurrence of an error in the selection of a data-access element in a data-storage array during each data access.

The various embodiments of the present disclosure described, complete the detection of the error in selection of a data-access element in the data-storage array in the same cycle of a memory operation i.e. within read/write operation in the data-storage array.

Further, the various embodiments described are used for both volatile and non volatile data-storage arrays i.e. memories. The disclosure has wide applications in the field of Petrochemical (Highly intelligent Combustible Gas Detectors), Automotive (human life safety systems in motor vehicles') and various fields where failure could risk to human life; as it helps in achieving high SIL (safety integrity levels).

Although the disclosure shows and describes only some embodiments, other embodiments, combinations, modifications, and applications are contemplated, and the embodiments are capable of changes or modifications within the scope of the inventive concept as expressed herein. The embodiments described hereinabove are further intended to explain best modes known of practicing the disclosure and to enable others skilled in the art to utilize the disclosure in such, or other, embodiments and with the various modifications required by the particular applications or uses of the disclosure. Accordingly, the description is not intended to limit the disclosure as disclosed herein.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A system including a data-storage array comprising:
a first error identifier operable to generate an error signal on selection of multiple data-access elements; and
a second error identifier operable to generate an error signal on absence of selection of a data-access element
during a data-access operation.

2. A system as claimed in claim 1 further comprising a common error-signal generator operable to provide an output on generation of either of said error signals.

3. A system as claimed in claim 1 wherein said error identifier comprises:
a first reference-voltage-level generator operable to generate a first reference-voltage level greater than voltage level produced when a single data-access element is selected and less than voltage level produced when no data-access element is selected;
a second reference-voltage-level generator operable to generate a second reference-voltage level less than a voltage level produced when a single data-access element is selected and greater than a voltage level produced when multiple data-access elements are selected;
a voltage-level detector operable to detect a voltage level for a selected data-access element; and
a comparator operable to compare the detected voltage level with the first and second reference-voltage level.

4. A system as claimed in 3 wherein said reference-voltage-level generator is operable to generate the first and second reference-voltage levels using at least one reference-data-access element configured to produce a reference-voltage level.

5. A memory device comprising:
a first error identifier operable to generate an error signal on selection of multiple data-access elements; and
a second error identifier operable to generate an error signal on absence of selection of a data-access element
during a data-access operation;

6. A memory device as claimed in claim 5 further comprising a common error-signal generator operable to provide an output on generation of either of said error signals.

7. A memory device as claimed in claim 5 wherein said error identifier comprises:
a first reference-voltage-level generator operable to generate a first reference-voltage level greater than a voltage level produced when a single data-access element is selected and less than a voltage level produced when no data-access element is selected;
a second reference-voltage-level generator operable to generate a second reference-voltage level less than a voltage level produced when a single data-access element is selected and greater than a voltage level produced when multiple data-access elements are selected;
a voltage-level detector operable to detect a voltage level on a selected data-access element; and
a comparator operable to comparie the detected voltage level with the first and second reference-voltage levels.

8. A memory device as claimed in claim 7 wherein said reference-voltage-level generator is operable to generate first and second reference-voltage levels using at least one reference-data-access element configured to produce a reference-voltage level.

9. A multi-bank architecture data-storage array comprising:
a first error identifier operable to generate an error signal on selection of multiple data-access elements; and
a second error identifier operable to generate an error signal on absence of selection of data-access element
during a data-access operation;

10. A multi-bank architecture data-storage array as claimed in claim 9, further comprising a common error-signal generator operable to provide an output on generation of either of said error signals.

11. A multi-bank architecture data-storage array as claimed in claim 9 wherein said error identifier comprises:
a first reference-voltage-level generator operable to generate a first reference-voltage level greater than a voltage level produced when a single data-access element is selected and less than a voltage level produced when no data-access element is selected;
a second reference-voltage-level generator operable to generate a second reference-voltage level less than a voltage level produced when a single data-access element is selected and greater than a voltage level produced when multiple data-access elements are selected;
a voltage-level detector operable to detect a voltage level on a selected data-access element; and
a comparator operable to compare the detected voltage level with the first and second reference-voltage levels.

12. A multi-bank architecture data-storage array as claimed in claim 11 wherein said reference-voltage-level generator is operable to generate first and second reference-voltage levels using at least one reference-data-access element configured to produce areference-voltage level.

13. A method for detecting data-access-element-selection errors during data access in data-storage arrays comprising:
generating an error signal on selection of multiple data-access elements; and
generating an error signal on absence of any data-access element selection
during a data access operation.

14. A method as claimed in claim 13 further comprising providing an output on generation of either of said error signals.

15. A method as claimed in claim 13 wherein detection of selection errors further comprises:
generating a first reference-voltage level greater than a voltage level produced when a single data-access element is selected and less than a voltage level produced when no data-access element is selected;
generating a second reference-voltage level less than a voltage level produced when a single data-access element is selected and greater than a voltage level produced when multiple data-access elements are selected;
detecting a voltage level on a selected data-access element; and
comparing the detected voltage level with the first and second reference-voltage levels.

16. A method as claimed in claim 15 wherein said reference-voltage levels are generated by providing at least one reference-data-access element configured to produce a reference-voltage level in the data-storage array.

17. A memory, comprising:
a group of data storage elements each operable to be accessed only individually; and
an error detection circuit operable to detect an access of more or fewer than one of the data storage elements during an access time.

18. The memory of claim 17 wherein the data storage elements comprise volatile memory cells.

19. The memory of claim 17 wherein the data storage elements comprise non volatile memory cells.

20. The memory of claim 17 wherein the error detection circuit comprises:
a first error detection portion operable to detect an access of none of the data storage elements during the access time; and
a second error detection portion operable to detect an access of more than one of the data [symbol] storage elements during the access time.

21. The memory of claim 17 wherein the error detection circuit comprises:
a first error detection portion operable to generate a first error signal in response to detecting an access of none of the data storage elements during the access time; and
a second error detection portion operable to generate a second error signal in response to detecting an access of more than one of the data [symbol] storage elements during the access time.

22. The memory of claim 17 wherein the error detection circuit comprises:
a first error detection portion operable to generate a first error signal in response to detecting an access of none of the data storage elements during the access time;
a second error detection portion operable to generate a second error signal in response to detecting an access of more than one of the data [symbol] storage elements during the access time; and
a logic circuit operable to generate a resulting error signal in response to either of the first and second error signals.

23. The memory of claim 17 wherein the error detection circuit comprises:
a reference element operable to draw a reference current that is less than a data current that an accessed one of the data storage elements is operable to draw; and
a comparator operable to generate an error signal in response to the reference current being greater than a current collectively drawn by the group of data storage elements during the access time, the error signal operable to indicate that no data storage element is being accessed during the access time.

24. The memory of claim 17 wherein the error detection circuit comprises:
a reference element operable to draw a reference current that is greater than a data current that an accessed one of the data storage elements is operable to draw; and
a comparator operable to generate an error signal in response to the reference current being less than a current collectively drawn by the group of data storage elements during the access time, the error signal operable to indicate that multiple data storage elements are being accessed during the access time.

25. The memory of claim 17 wherein the error detection circuit comprises:
a reference element operable to generate a voltage that is greater than a data voltage that an accessed one of the data storage elements is operable to generate; and
a comparator operable to generate an error signal in response to the reference voltage being less than a voltage collectively generated by the group of data storage elements during the access time, the error signal operable to indicate that no data storage element is being accessed during the access time.

26. The memory of claim 17 wherein the error detection circuit comprises:
a reference element operable to generate a reference voltage that is less than a data voltage that an accessed one of the data storage elements is operable to draw; and
a comparator operable to generate an error signal in response to the reference voltage being greater than a voltage collectively generated by the group of data storage elements during the access time, the error signal operable to indicate that multiple data storage elements are being accessed during the access time.

27. The memory of claim 17, further comprising an access circuit operable to access a selected one of the data storage elements in the group during the access time.

28. The memory of claim 17, further comprising:
wherein the group of data storage elements compose at least a portion of a column; and
word lines each coupled to a respective one of the data storage elements.

29. A memory, comprising:
a group of data storage elements; and
an error detection circuit operable to detect an access of a first number of the data storage elements during an access time, the first number being different from a second number of the data storage elements selected for access during the access time.

30. A system, comprising:
a memory including
a group of data storage elements; and
an error detection circuit operable to detect an access of a first number of the data storage elements during an access time, the first number being different from a second number of the data storage elements selected for access during the access time; and
a controller coupled to the memory.

31. The system of claim 30 wherein the memory and the controller are disposed on a same integrated circuit die.

32. The system of claim 30 wherein the memory and the controller are respectively disposed on first and second integrated circuit dies.

33. The system of claim 30 wherein the controller comprises a processor.

34. A system, comprising:
a memory including
a group of data storage elements each operable to be accessed only individually; and
an error detection circuit operable to detect an access of more or fewer than one of the data storage elements during an access time; and
a controller coupled to the memory.

35. A method, comprising:
selecting a single data storage element from a group of data storage elements for accessing during an access period; and
indicating an error if multiple or no data storage elements from the group are activated during the access period.

36. The method of claim 35, further comprising selecting the single data storage element for reading during the access period.

37. The method of claim 35, further comprising selecting the single data storage element for writing during the access period.

38. The method of claim 35, further comprising indicating the error by generating an error signal.

39. A method, comprising:
selecting a first number of data storage elements from a group of data storage elements for accessing during an access period; and
indicating an error if a second number of data storage elements from the group are activated during the access period, the second number being different from the first number.
